(19) United States
(12) Patent Application Publication
(10) Pub. No.: US 2016/0118700 A1
(43) Pub. Date: Apr. 28, 2016

(54) TRACTION BATTERY THERMAL MANAGEMENT

(71) Applicant: FORD GLOBAL TECHNOLOGIES, LLC, Dearborn, MI (US)

(72) Inventors: Sai K. PERUMALLA, Rochester Hills, MI (US); Bhaskara BODDAKAYALA, Canton`, MI (US); Neil Robert BURROWS, White Lake Township, MI (US); Saravanan PARAMASIVAM, South Lyon, MI (US); David MOSCHET, Dearborn, MI (US)

(21) Appl. No.: 14/522,641

(22) Filed: Oct. 24, 2014

(51) Int. Cl. H01M 10/6554; B60L 11/18; H01M 10/42; H01M 10/6556; H01M 10/625; H01M 10/613

(52) U.S. Cl. CPC H01M 10/6554; H01M 10/625; H01M 10/613; H01M 10/425; H01M 10/6556; B60L 11/1874; H01M 2010/4271; H01M 2220/20

(57) ABSTRACT

A vehicle traction battery assembly includes at least one battery cell array, and an electronics assembly configured to manage power flow of the battery assembly. The vehicle traction battery assembly also includes a thermal plate defining a first portion in contact with the at least one array and a second portion in contact with the electronics assembly. During power flow, both of the at least one array and the electronics assembly exchange heat with the thermal plate.

### TECHNICAL FIELD

The present disclosure relates to thermal management of vehicle traction batteries used to operate hybrid and electric vehicles.

### BACKGROUND

Hybrid and electric vehicles commonly demand significant amounts of energy from a high voltage traction battery. The energy may be used to drive motors and electrical accessories. The traction batteries can include a large number of interconnected battery cells. Maintaining battery temperature within a desired operating range may promote proper battery function and enhance battery longevity. Also, it may be beneficial to limit the differential in temperature across individual cells. Thermal management devices may be used to regulate battery temperature. For example, directing passenger cabin air or external air across a battery may help regulate temperature. Additionally, electric heating systems may be used to warm a battery during low temperature conditions.

### SUMMARY

In at least one embodiment, a vehicle traction battery assembly includes at least one battery cell array, and an electronics assembly configured to manage power flow of the battery assembly. The vehicle traction battery assembly also includes a thermal plate defining a first portion in contact with the at least one array and a second portion in contact with the electronics assembly. During power flow, both of the at least one array and the electronics assembly exchange heat with the thermal plate.

In at least one embodiment, a vehicle traction battery assembly includes a thermal plate including internal flow channels arranged to circulate a thermal agent. The traction battery assembly also includes at least one battery cell array in contact with a first side of the thermal plate to exchange heat during power flow. The traction battery assembly further includes an electronics assembly having a housing in contact with an opposing side of the thermal plate to exchange heat during operation.

In at least one embodiment, a vehicle includes a powertrain including a battery-powered electric machine and a traction battery assembly for providing power to the electric machine. The traction battery assembly includes at least one battery cell array, and an electronics assembly configured to manage power flow of the at least one array. The traction battery assembly further includes a thermal plate defining a first portion in contact with the at least one array, and a second portion in contact with the electronics assembly. During power flow, both of the at least one array and the electronics assembly exchange heat with the thermal plate.

### BRIEF DESCRIPTION OF THE DRAWINGS

FIG. 1 is a schematic view of a hybrid-electric vehicle.

FIG. 2 is a schematic view of a traction battery assembly.

FIG. 3 is a schematic view of an alternate embodiment traction battery assembly.

FIG. 4 is a schematic view of a further alternate embodiment traction battery assembly.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

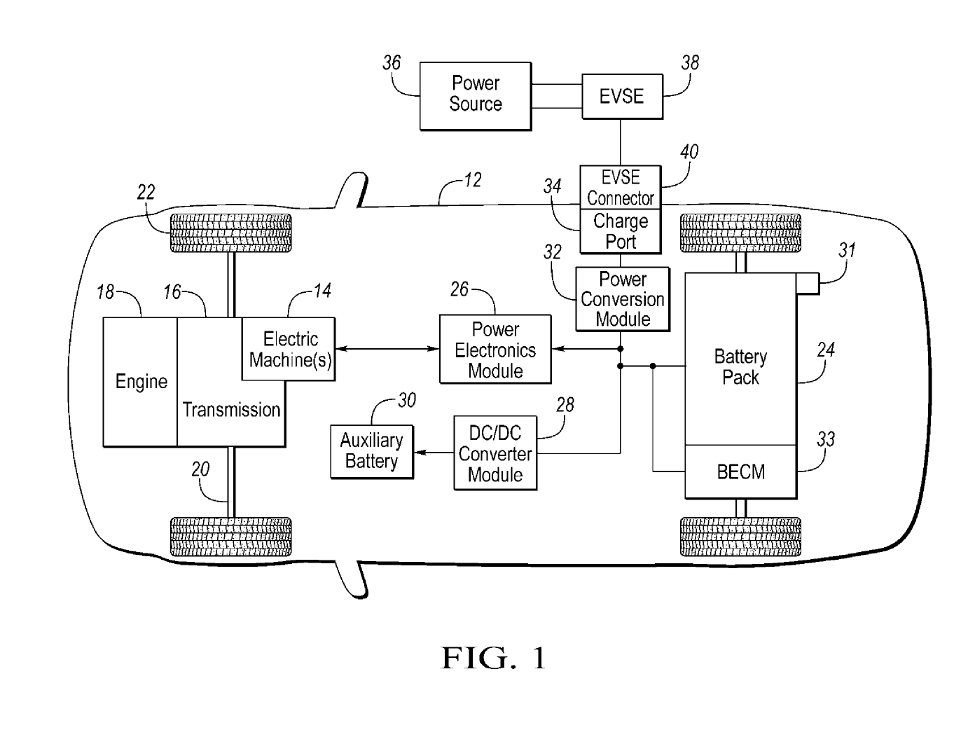

FIG. 1 depicts a schematic of a plug-in hybrid-electric vehicle (PHEV). The powertrain of vehicle 12 includes one or more electric machines 14 mechanically coupled to a hybrid transmission 16. The electric machines 14 may be capable of operating as a motor or a generator to receive or provide electrical power, respectively. In addition, the hybrid transmission 16 may be mechanically connected to an engine 18. The hybrid transmission 16 may also be mechanically connected to a drive shaft 20 that is mechanically coupled to the wheels 22. The electric machines 14 can provide propulsion and deceleration capability when the engine 18 is turned on or off. When the electric machines 14 are operated as generators, they may provide fuel economy benefits by recovering energy during deceleration through regenerative braking. The electric machines 14 reduce pollutant emissions of the powertrain and increase fuel economy by reducing the work load of the engine 18.

The electric machines 14 may be battery-powered. A traction battery or battery pack 24 stores energy that can be used by the electric machines 14, as well as other vehicle accessories having an electrical load. The traction battery 24 may provide a high voltage direct current (DC) output from one or more battery cell arrays, sometimes referred to as battery cell stacks, within the traction battery 24. The battery cell arrays may include one or more battery cells.

The battery cells, such as a prismatic, cylindrical, or pouch cells, may include electrochemical cells that convert stored chemical energy to electrical energy. The cells may further include a housing, a positive electrode (cathode) and a negative electrode (anode). An electrolyte may allow ions to move between the anode and cathode during discharge, and then return during recharge. Terminals may allow current to flow out of the cell for use by the vehicle. When positioned in an array with multiple battery cells, the terminals of each battery cell may be aligned with opposing terminals (positive and negative) adjacent to one another and a busbar may assist in facilitating an electrical series connection between the multiple battery cells. The battery cells may also be arranged in parallel such that similar terminals (positive and positive or negative and negative) are adjacent to one another.

The traction battery 24 may be electrically connected to one or more power electronics modules 26. One or more contactors may isolate the traction battery 24 from other components when opened and connect the traction battery 24 to other components when closed. The power electronics module 26 may also be electrically connected to the electric machines 14 and regulate bi-directional transfer of electrical energy between the traction battery 24 and the electric machines 14. For example, a traction battery 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. The description herein is equally applicable to a pure electric vehicle. In a pure electric vehicle, the hybrid transmission 16 may be a gear box connected to an electric machine 14 and the engine 18 is not present.

As discussed above, the traction battery 24 may provide energy for other vehicle electrical systems in addition to providing energy for propulsion. A vehicle power system may include a DC/DC converter module 28 for conditioning voltage for various uses. The DC/DC converter converts the high voltage DC output of the traction battery 24 to a low voltage DC supply that is compatible with other vehicle electrical loads. Other high-voltage loads, such as compressors and electric heaters, may be connected directly to the high-voltage without the use of a DC/DC converter module 28. In certain vehicles, the low-voltage systems are electrically connected to an auxiliary battery 30 (e.g., a 12 volt battery). In at least one embodiment, the DC/DC converter is positioned in close proximity or adjacent to the traction battery 24.

A battery energy control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24. Although a single temperature sensor is depicted in the schematic of FIG. 1, multiple sensors may be employed to individually monitor separate cells and/or arrays of cells within the traction battery 24.

The battery pack 24 may be recharged by an external power source 36, for example, such as an electrical outlet. The external power source 36 may be electrically connected to electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus (e.g., Controller Area Network (CAN)) or via dedicated electrical conduits.

The battery cells and/or the battery electronics may generate heat when in use. Thermal management of the traction battery may be more difficult in certain ambient conditions because the battery needs to be maintained within a targeted temperature range while minimizing the temperature deviation within each individual cell and across the cell string. Different battery pack configurations may be used to address individual vehicle variables including packaging constraints and power requirements. The battery cells may be thermally regulated with a thermal management system to help manage an overall temperature of the battery. Examples of thermal management systems may include air cooling systems, liquid cooling systems and a combination of air and liquid systems. Certain vehicle package limitations can insulate the battery pack from ambient conditions, for example, by placing battery pack inside the vehicle passenger compartment. However, such an arrangement may result in reduced vehicle usable space.

Managing the temperature of the traction battery assembly considering several heat sources such as a DC/DC converter, a BECM, BEC, battery charger, and/or other battery electronics in an underbody location creates several packaging and thermal management challenges. It is contemplated that additional electronics beyond those listed above may benefit from thermal management. Particularly difficult is the provision of effective cooling for the battery and the DC/DC converter on same foot print. Also, considering the size of battery array and the DC/DC converter there are further challenges in manufacturing a single thermal plate large enough to accommodate the battery cells, the DC/DC converter, and other battery electronics. Liquid cooled cells and some electronics require a high thermal conductive surface for the heat transfer between the cells and electronics to a coolant agent.

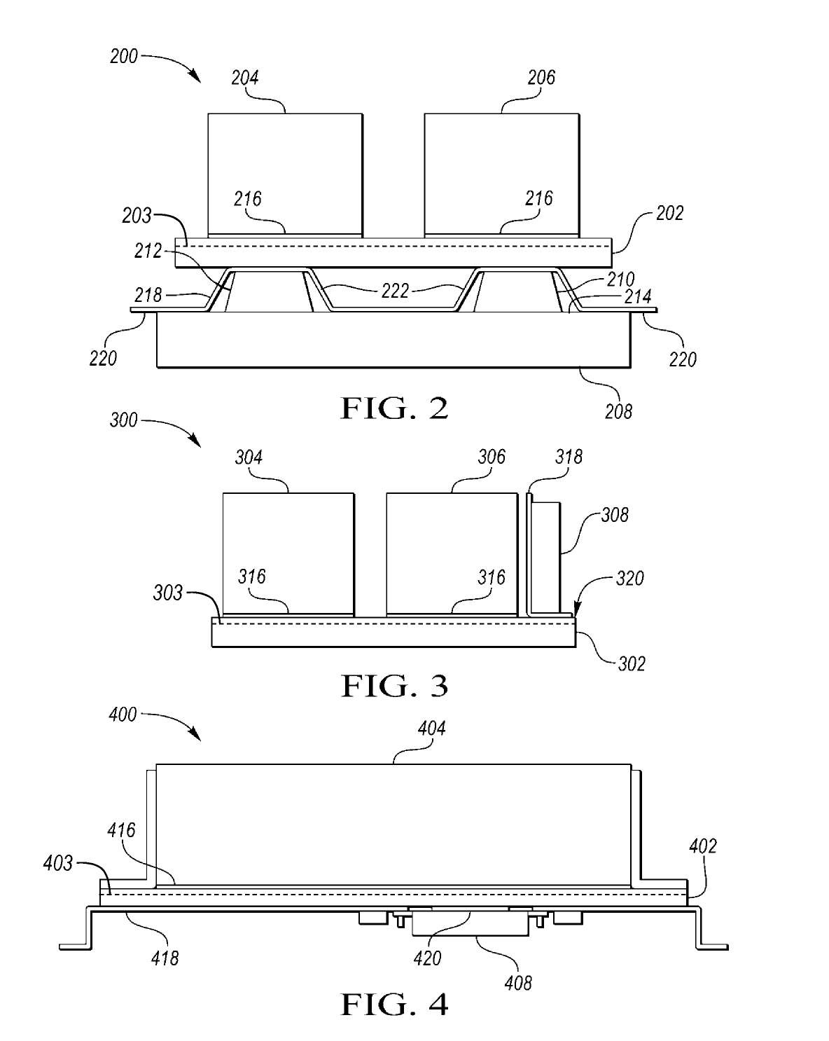

Referring to the schematic of FIG. 2, a vehicle traction battery assembly 200 is provided in which a single thermal plate assembly 202 is shared by two or more heat sources. In the example of the traction battery assembly 200, the heat sources include a first battery cell array 204, a second battery cell array 206, and an electronics assembly 208. The plurality of heat sources are in contact with both opposing sides of the thermal plate assembly 202. Utilizing both sides of the thermal plate eliminates the need to package two cold plates. Also, this arrangement may enable the entire vehicle traction battery assembly 200 to be packaged into smaller locations in the vehicle. Further, this arrangement may increase the energy density of the traction battery.

In at least one embodiment the electronics assembly 208 includes heat sink protrusions 210, 212 extending from an outer portion 214 of the electronics assembly 208 to contact the thermal plate assembly 202. The heat sink protrusions 210, 212 operate to provide an increased surface area of the electronics assembly 208, thereby enhancing heat transfer efficiency.

A thermal interface material 216, also referred to as TIM, is positioned between the first battery cell array 204 and the thermal plate assembly 202. Similarly, thermal interface material 216 is arranged between the second battery cell array 206 and the thermal plate assembly 202. The thermal interface material 216 may be formed from a di-electric material and provide electrical isolation between the battery cells and the thermal plate assembly 202. Also, the thermal interface material 216 may be compressible and conform to surface transitions and irregularities on the underside of the battery cell arrays. The conformity of the interface material 216 enhances the thermally conductive surface area contact, thereby improving the heat transfer between the battery cells and the thermal plate assembly 202. For example, the thermal interface material 216 enhances the heat transfer by filling any voids or gaps between the battery cell arrays 204, 206 and the thermal plate 202.

Still referring to FIG. 2, a support structure 218 is provided for mounting the electronics assembly 208 to the thermal plate assembly 202. The support structure 218 may include extension portions 220 to secure the traction battery assembly 200 to a vehicle structure. In the example of FIG. 2, the support structure 218 further includes formations 222 to accommodate the heat sink protrusions 210, 212 of the electronics assembly 208.

In at least one embodiment, the thermal plate includes internal flow channels arranged to circulate a thermal agent, such as a fluid coolant, through the thermal plate. For example, the thermal agent may be a coolant liquid such as a fifty percent mixture of water and glycol. The coolant may be additionally mixed with various other agents having high heat transfer properties. Other alternative fluids may also be suitable, including various refrigerants. The thermal agent may be circulated within the thermal plate 202 received from an inlet connected to a thermal agent reservoir and be discharged to an outlet connected to a discharge tank. A pattern of conduits may route the flow of the thermal agent in a desired pattern within the internal cavity of the thermal plate. In at least one embodiment, the thermal agent is cycled through the thermal plate in a serpentine pattern.

In at least one embodiment, the structure of the thermal plate assembly 202 comprises a multi-piece housing. The assembly may be a combination of die cast structures, each including integral features formed in during casting. Line 203 of FIG. 2 may represent a seam between an upper portion and a lower portion of the thermal plate assembly 202. In one example, the support structure 218 may be integrally formed with a lower portion of the thermal plate assembly 202. In further embodiments, there may be a combination of stampings and castings comprising the upper and/or lower components of the thermal plate assembly 202. Further still, a combination of multiple materials may be employed across the upper and/or lower portions of the thermal plate assembly 202.

The internal flow channels may be spaced such that the thermal plate provides adequate heat exchange when the thermal agent is cycled. Depending on the locations of the various heat sources, certain portions of the traction battery assembly generate more heat than other portions. Close proximity of heat sources may serve to create a heat concentration zone. In order to compensate for the non-uniform distribution of the generation of heat, a spacing density of the internal flow channels may be increased near the high heat generating portions of the traction battery assembly. Conversely, to optimize cost and efficiency, the spacing density of the internal flow channels may be reduced near low heat generating portions of the traction battery assembly.

In further embodiments, the flow velocity of the thermal agent may be increased near high heat generating portions of the traction battery assembly, and conversely reduced near low heat generating portions of the traction battery assembly. The changes in flow velocity of the thermal agent may operate to provide increased heat transfer properties at the high heat generating portions of the traction battery assembly.

Alternate configurations are available such that the electronics assembly and the battery cell arrays can be placed beside each other, on the same side of the plate. Referring to FIG. 3, an alternate embodiment vehicle traction battery assembly 300 is provided having a thermal plate assembly 302 disposed beneath a first battery cell array 304 and a second battery cell array 306. Similar to previous embodiments, the traction battery assembly 300 includes a thermal interface material 316 between each of the battery cell arrays and the thermal plate assembly 302. However, in the embodiment of FIG. 3, the electronics assembly 308 is disposed on the same side of the thermal plate assembly 302 as the battery cell arrays 304, 306. A support structure 318 may be attached to an upper portion 320 of the thermal plate assembly 302. The support structure 318 may be a thermally conductive material, such as an aluminum alloy for example, that may be brazed, welded, or bolted to the thermal plate assembly 302. In this way, each of the heat sources is mounted beside each other. As can be noted from FIG. 3, the support structure is significantly reduced in size compared to previous embodiments. In this way, the thermal plate assembly 302 may be directly mounted to a battery housing or the surrounding vehicle structure. The present arrangement may be particularly useful if the electronics assembly 308 is smaller in size, and also if there are vertical space constraints in the available vehicle package. Further arranging the multiple seat sources on a single side of the thermal plate may reduce complexity of the internal flow channels of the thermal plate assembly 302.

Similar to previous embodiments, line 303 may correspond to a seam joint between an upper portion and a lower portion of the thermal plate assembly 302. Additionally, mounting features of the support structure 318 may be integrally formed in the upper portion of the thermal plate assembly 302.

Referring to FIG. 4, a further alternate embodiment is provided in which the thermal resistance is reduced between the thermal plate assembly 402 and the electronics assembly 408. The reduction is achieved by reducing intermediate material layers between the electronics assembly 408 and the thermal plate assembly 402. In at least one embodiment, support structure defines an aperture to allow the electronics assembly to protrude through a portion of the support structure to contact the thermal plate. Similar to previous embodiments, thermal interface material 416 is disposed between the battery cell array 404 and the thermal plate assembly 402. Also, a second thermal interface material 420 is disposed between the electronics assembly 408 and the thermal plate assembly 402.

As discussed above in reference to previous embodiments, line 403 may correspond to a seam joint between an upper portion and a lower portion of the thermal plate assembly 402. The support structure 418, as well as mounting features for the electronic assembly 408, may each be integrally formed in the lower portion of the thermal plate assembly 402.

The present disclosure provides a traction battery that employs a unique configuration of multiple components to efficiently manage heat. The arrangement of components helps to reduce heat accumulation in the battery cells and electronics during power flow for the powertrain and other vehicle loads. The arrangements described in the present disclosure may also reduce the number of thermal agent flow connections required inside the battery. The thermal agent flow that would have been directed to two separate thermal plates can be used to flow through a single shared plate, increasing the heat rejection capability. Employing a single plate to regulate temperature of several battery components also reduces package space required for the battery. Although not always explicitly illustrated, one of ordinary skill in the art will recognize that one or more of the illustrated component or functions may be duplicated in a thermal management device depending upon the particular strategy being used.

While several embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle traction battery assembly comprising:
at least one battery cell array;
an electronics assembly configured to manage power flow of the at least one array; and
a thermal plate defining a first portion in contact with the at least one array and a second portion in contact with the electronics assembly such that during power flow both of the at least one array and the electronics assembly exchange heat with the thermal plate.

2. The vehicle traction battery assembly of claim 1 wherein the first portion is disposed on a first side of the thermal plate, and the second portion is disposed on an opposing side of the thermal plate.

3. The vehicle traction battery assembly of claim 1 wherein the first portion and the second portion are each disposed on a same side of the thermal plate, and the at least one battery cell array and the electronics assembly are mounted beside each other.

4. The vehicle traction battery assembly of claim 1 further comprising a support structure for mounting the electronics assembly to the thermal plate, the support structure defining an aperture arranged such that a portion of the electronics assembly protrudes through the aperture to contact the thermal plate.

5. The vehicle traction battery assembly of claim 1 wherein the thermal plate includes internal flow channels arranged to circulate a thermal agent through the thermal plate.

6. The vehicle traction battery assembly of claim 5 wherein the traction battery assembly defines a heat concentration zone during power flow, and the thermal plate is configured such that a spacing between the internal flow channels decreases near the heat concentration zone.

7. The vehicle traction battery assembly of claim 5 wherein the traction battery assembly defines a heat concentration zone during power flow, and the thermal plate is configured such that a flow velocity of the thermal agent increases near the heat concentration zone.

8. The vehicle traction battery assembly of claim 1 wherein the electronics assembly includes a heat sink protrusion extending therefrom to increase surface area.

9. The vehicle traction battery assembly of claim 1 wherein the thermal plate includes a heat sink protrusion extending therefrom, and the electronics assembly is mounted to the heat sink.

10. The vehicle traction battery of claim 1 wherein the first portion and the second portion comprise an upper portion and a lower portion, respectively, and the upper portion and the lower portion are formed from one of a cast structure, a stamped structure, or a combination of a cast structure and a stamped structure.

11. A vehicle traction battery assembly comprising:
a thermal plate including internal flow channels arranged to circulate a thermal agent;
at least one battery cell array in contact with a first side of the thermal plate to exchange heat during power flow; and
an electronics assembly having a housing in contact with a second side of the thermal plate opposite the first side to exchange heat during operation.

12. The vehicle traction battery assembly of claim 11 wherein, during operation, the at least one battery cell array defines a heat concentration zone, and the thermal plate is configured such that a spacing between the internal flow channels decreases near the heat concentration zone.

13. The vehicle traction battery assembly of claim 11 wherein, during operation, the at least one battery cell array defines a heat concentration zone, and the thermal plate is configured such that a flow velocity of the thermal agent increases near the heat concentration zone.

14. The vehicle traction battery assembly of claim 11 further comprising a support structure for mounting the electronics assembly to the thermal plate, the support structure defining an aperture arranged such that a portion of the electronics assembly protrudes through the aperture to contact the thermal plate.

15. The vehicle traction battery assembly of claim 11 wherein the thermal plate includes a heat sink protrusion extending therefrom, and the electronics assembly is mounted to the heat sink protrusion.

16. A vehicle comprising:
a powertrain including a battery-powered electric machine; and
a traction battery assembly for providing power to the electric machine, and including
at least one battery cell array,
an electronics assembly configured to manage power flow of the at least one array, and
a thermal plate defining a first portion in contact with the at least one array, and a second portion in contact with the electronics assembly such that during power flow both of the at least one array and the electronics assembly exchange heat with the thermal plate.

17. The vehicle of claim 16 further comprising a support structure for mounting the electronics assembly to the thermal plate, the support structure defining an aperture arranged such that a portion of the electronics assembly protrudes through the aperture to contact the thermal plate.

18. The vehicle of claim 16 wherein the thermal plate includes internal flow channels arranged to circulate a thermal agent through the thermal plate.

19. The vehicle of claim 16 wherein the electronics assembly includes a DC/DC converter for conditioning voltage provided to vehicle electrical loads.

20. The vehicle of claim 16 further comprising a compartment for housing the traction battery assembly, wherein the compartment is environmentally isolated from ambient conditions.
